(19) United States
(12) Patent Application Publication
(10) Pub. No.: US 2015/0166795 A1
(43) Pub. Date: Jun. 18, 2015

(54) Anti-Glare Coatings with Ultraviolet-Absorbing Particles and Methods for Forming the Same

(71) Applicant: Intermolecular Inc., San Jose, CA (US)

(72) Inventors: Nikhil Kalyankar, Mountain View, CA (US); Scott Jewhurst, Redwood City, CA (US); Liang Liang, Taylor, MI (US); James Mulligan, Plymouth, MI (US)

(73) Assignee: Intermolecular Inc., San Jose, CA (US)

(21) Appl. No.: 14/108,551

(22) Filed: Dec. 17, 2013

(51) Int. Cl. C09D 5/00

(52) U.S. Cl. CPC C09D 5/006

(57) ABSTRACT

Embodiments provided herein describe optical coatings, panels having optical coatings thereon, and methods for forming optical coatings and panels. A substrate is provided. A coating is formed above the substrate. The coating includes a plurality of micro-particles including a UV-absorbing material and has a surfaces roughness suitable to provide the coating with anti-glare properties.

The present invention relates to optical coatings. More particularly, this invention relates to optical coatings that improve, for example, the anti-glare performance of transparent substrates and methods for forming such optical coatings.

### BACKGROUND OF THE INVENTION

Anti-glare coatings, and anti-glare panels in general, are desirable in many applications including, portrait glass, privacy glass, and display screen manufacturing. Such optical coatings scatter specular reflections into a wide viewing cone to diffuse glare and reflection. In some applications, it is also desirable for the coatings to provide the ability to absorb or block ultraviolet (UV) light to prevent damage or fading to the particular device using the anti-glare coating due to UV radiation exposure.

Traditionally, multiple processes or treatments are necessary to achieve anti-glare and UV-absorbing properties in optical coatings. For example, a coating or texturing step is typically performed to achieve effective surface roughness (e.g., 0.2 to 0.8 micrometers (μm)) for anti-glare performance. Usually the surface is then coated with a layer containing a UV-absorber. The thickness of this layer is dictated by the desired UV-absorbing performance and is typically on the order of several tens of micrometers (e.g., 20-50 μm).

Such methods are expensive and have low throughput (i.e., a low rate of manufacture), as the texturing process typically requires the use of highly corrosive and toxic etchants, thus necessitating significant safety and waste disposal protocols. Additionally, these multi-step processes are difficult to optimize and reduce to practice due to material and interfacial compatibility issues.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional view of a substrate;

FIG. 2 is cross-sectional view of the substrate of FIG. 1 with an anti-glare coating formed thereon according to some embodiments of the present invention;

FIG. 3 is a cross-sectional view of the substrate of FIG. 1 with an anti-glare coating formed thereon according to some embodiments of the present invention; and

FIG. 4 is a flow chart of a method for forming an anti-glare coating, or for forming a coated article, such as an anti-glare panel, according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

The term “horizontal” as used herein will be understood to be defined as a plane parallel to the plane or surface of the substrate, regardless of the orientation of the substrate. The term “vertical” will refer to a direction perpendicular to the horizontal as previously defined. Terms such as “above”, “below”, “bottom”, “top”, “side” (e.g. sidewall), “higher”, “lower”, “upper”, “over”, and “under”, are defined with respect to the horizontal plane. The term “on” means there is direct contact between the elements. The term “above” will allow for intervening elements.

Embodiments described herein provide for optical coatings, and methods for forming optical coatings, that improve the anti-glare performance of transparent substrates, as well as block or absorb ultraviolet (UV) light. In accordance with some embodiments, this is accomplished by forming a coating above a transparent substrate. The coating includes, or has embedded therein, particles (e.g., micro-particles) that contain a UV-absorbing material. The size and distribution of the particles in the coating are such that an upper surface of the layer has a series of surface features thereon which give the layer an effective surface roughness or texture (e.g., between 0.2 micrometers (μm) and 0.8 μm) that is suitable for providing the layer with anti-glare properties.

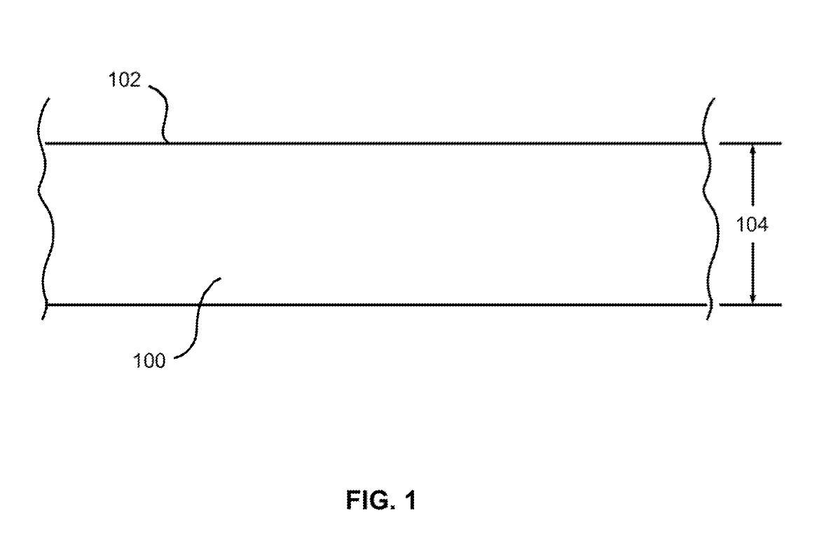

FIG. 1 illustrates a transparent substrate 100 according to some embodiments. In some embodiments, the transparent substrate 100 is made of glass and has an upper surface 102 and a thickness 104 of, for example, between 0.1 and 2.0 centimeters (cm). Although only a portion of the substrate 100 is shown, it should be understood that the substrate 100 may have a width of, for example, between 5.0 cm and 2.0 meters (m). In some embodiments, the substrate 100 is made of a transparent polymer.

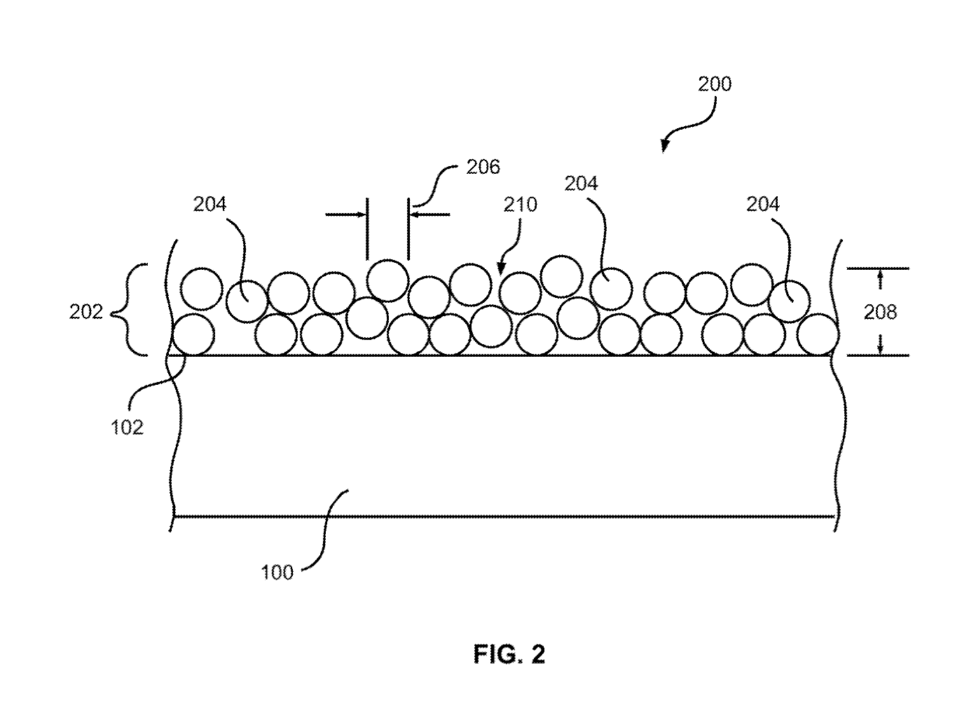

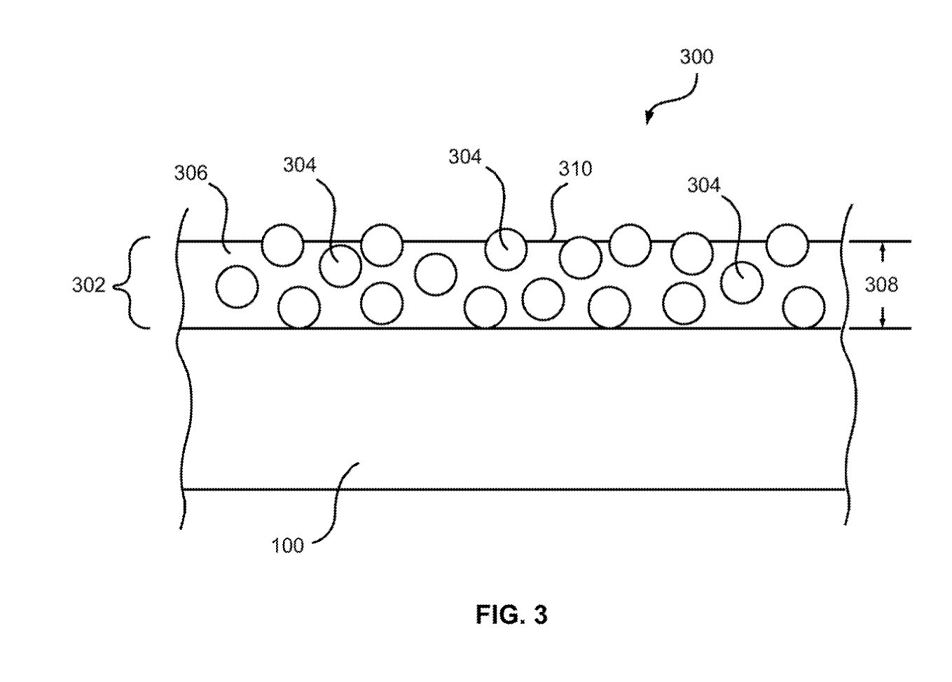

FIGS. 2 and 3 illustrate coated articles (or anti-glare panels) 200 and 300, respectively, which include the transparent substrate 100, or a similar substrate.

Referring now to FIG. 2, the coated article 200 includes the transparent substrate 100 and an anti-glare coating 202. The anti-glare coating is formed above the upper surface 102 of the substrate 100 and includes a plurality of micro-particles 204, which include a UV-absorbing material. In some embodiments, the micro-particles 204 are substantially spherical and have a diameter (or width) 206 of between 0.1 and 10 μm. Although the coating 202 is shown as having essentially two “layers” of the micro-particles 204, it should be understood that in some embodiments, a significantly greater number of micro-particles 204 (and/or layers of the micro-particles 204) may be used such that a thickness 208 of the coating 202 may be between about 1 and 100 μm.

In some embodiments, the micro-particles 204 are polymeric, inorganic or hybrid particles with a plurality of pores therein, in which the UV absorbing material is dispersed. Examples of porous particles include aerogels, silica gel matting agents, zeolite micro-particles, porous hollow silica or glass sphere, etc. In some embodiments, the micro-particles 204 are “core-shell” micro-particles, which have a non-porous shell (e.g., organic or inorganic) surrounding a hollow core that is filled with a UV-absorbing material.

Exemplary UV-absorbing materials include, for example, benzophenone (BP) derivatives, benzotriazole (BTA) derivatives, 2-hydroxyphenyl-s-triazine (HPT) derivatives, cyanoacrylate derivatives, nano zinc oxide, nano titanium, dioxide, nano cerium oxide, and combinations thereof.

Still referring to FIG. 2, although not specifically shown, the coating 202 also includes a binder material covering and/or interconnecting the micro-particles 204. Suitable binder materials include, but are not limited to tetraethoxysilane (TEOS), silicon alkoxides, such as methyltriethoxysilane (MTES), tetramethoxysilane (TMOS), tetrapropoxysilane (TPOS), etc., as well as polysiloxane, tetraalkoxysilane, alkyltrialkoxysilane, oligomeric silicon alkoxide, and soluble silicates, or any combination thereof. Additionally, titanium ethoxide and aluminum ethoxide may be used, as well as polymeric binder materials. Further, although not shown, it should be understood that the coating 202 may also include other particles, including non-UV-absorbing particles, such as spherical silica nano-particles (e.g., 3-200 nanometers (nm)).

The anti-glare coating 202 may be deposited and/or formed using various methods. In some embodiments, the coating 202 is deposited on the transparent substrate 100 using a sol-gel system in which a sol-gel formulation is prepared and deposited onto the substrate 100 using, for example, spin coating. A solvent in the formulation may be removed and/or the coating 202 may be cured using, for example, a thermal cure, a UV cure, or a combination thereof.

Still referring to FIG. 2, the micro-particles 204 provide an upper surface 210 of the anti-glare coating 202 with a series a surface features (i.e., texturing or roughness) formed thereon, which cause the thickness 208 to vary. For example, due to the surface features, the upper surface 210 of the coating 202 may have an average an effective surface roughness ranging, for example, from 0.2 to 0.8 μm. As will be appreciated by one skilled in the art, such a surface roughness is suitable to provide the coating 202 with anti-glare properties.

In some embodiments similar to that shown in FIG. 2, the coating thickness and UV-absorbing particle loading (i.e., density) controls the ability of the coating to absorb UV light. The anti-glare properties may be achieved by surface scattering only and may be dependent on the surface roughness imparted by the UV-absorbing particles.

Referring now to FIG. 3, the coated article 300 includes the transparent substrate 100 and an anti-glare coating 302. The anti-glare coating 302 is formed above the upper surface 102 of the substrate 100 and includes a plurality of micro-particles 304 embedded within a coating matrix (or matrix material) 306. The micro-particles 304 may be similar in size, shape, and composition to the micro-particles 204 shown in FIG. 2 and described above.

As with the coating 202 shown in FIG. 2, a thickness 308 of the coating 302 may be between about 1 and 100 μm. However, as is apparent when comparing FIG. 2 to FIG. 3, the micro-particles 304 are packed less densely than those shown in FIG. 2 because, for example, of the use of the coating matrix 306.

In some embodiments, the coating matrix 306 (and/or the coating 302 as a whole) is formed using a sol-gel formulation. In addition to the particles 304, the sol-gel formulation may include a combination of matrix forming silanes or siloxanes containing two or more of the following: tetraalkoxysilane, oligomeric alkoxysiloxanes, bis(alkoxysilanes), silesquioxanes, dipodal alkoxysilane and/or (alkyl/aryl)trialkoxysilane. An organic solvent, such as an alcohol, ketone, ester, tetrahydrofuran (THF), etc. may be added which serves as a cosolvent for the ingredients. The formulation may also include an accelerator or a catalyst such as an acid, a base, a metal carboxylate or any other type of chemical which can catalyze the sol-gel reaction and water for hydrolysis of the alkoxide groups of the silanes/siloxanes. Additionally, inorganic nano-particles (e.g., 3-200 nm), such as spherical silica, may be added to provide structural rigidity to the matrix, along with a stabilizer, such as a surfactant.

In some embodiments, the coating matrix 306 also includes a UV-absorbing (or blocking) components or materials, which may be different from the UV-absorbing material(s) within the micro-particles 304. Examples of such UV-absorbing materials include, but are not limited to, organic dyes and inorganic oxides, such as titanium dioxide, zinc oxide, cerium oxide, etc.

In some embodiments, the formulation is deposited onto the transparent substrate 100 (e.g., via spin coating) to form a gelled or solidified layer. A solvent in the formulation may be removed and/or the coating 202 may be cured using, for example, a thermal cure, a UV cure, or a combination thereof.

Still referring to FIG. 3, the micro-particles 304 provide an upper surface 310 of the anti-glare coating 302 with a series a surface features (i.e., texturing or roughness) formed thereon, which cause the thickness 308 to vary. For example, due to the surface features, the upper surface 310 of the coating 302 may have an average an effective surface roughness ranging, for example, from 0.2 to 0.8 μm. As will be appreciated by one skilled in the art, such a surface roughness is suitable to provide the coating 202 with anti-glare properties, particularly when combined with a UV-absorbing material within the coating matrix 306.

In some embodiments similar to that shown in FIG. 3, the coating thickness and UV-absorbing particle loading (i.e., density) controls the ability of the coating to absorb UV light. The UV-absorbing properties may be enhanced by the presence of a UV-absorbing material in the coating matrix 306. The anti-glare properties may be achieved by both surface scattering (i.e., the surface roughness imparted by the light scattering UV-absorbing particles) and internal scattering due to refractive index contrast between the particles 304 and coating matrix 306.

In some embodiments, the UV-absorbing micro-particles may be combined with other light scattering particles in a particle-binder/composite coatings system. The UV-absorbing particles may be chosen from following: porous micro-particles, flocculating porous nano-particles, and a combination of porous dispersed nano-particles and porous micro-particles.

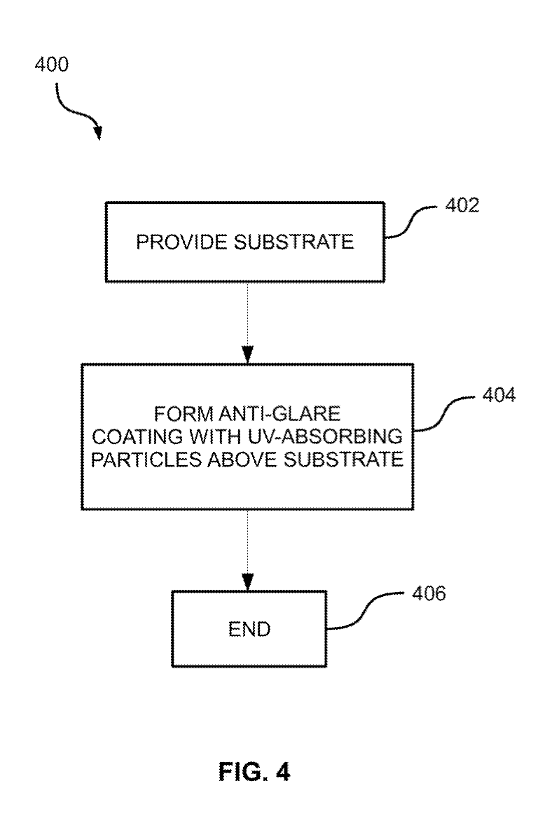

FIG. 4 illustrates a method 400 for forming an anti-glare coating, or for forming a coated article, such as an anti-glare panel, according to some embodiments. At step 400, the method 400 begins by providing a substrate, such as the transparent substrate 100 described above. At step 402, an anti-glare coating is formed above the substrate. The anti-glare coating includes UV-absorbing particles, such as those described above. At step 406, the method 400 ends, with an anti-glare coating having been formed in a single step, at least in some embodiments.

The UV-absorbing (and/or UV-blocking) properties (A_{UV}) of the anti-glare coatings provided herein may be described using Beer-Lambert's law,

A_{UV}=εCd, (1)

where ε is the extinction coefficient of the particular UV-absorbing material(s) used, C is the concentration of the UV-absorbing material(s), and d is path length (i.e., coating thickness).

The path length, d, depends on coating thickness and can be controlled by amount of UV-absorbing particles in the coating, as well as amount/thickness of the coating matrix (i.e., in embodiments with the particles embedded with a coating matrix). The concentration of UV-absorbing material(s) can be controlled by the amount of UV-absorbing material(s) absorbed or held within each particle, as well as amount of UV-absorbing material(s) present in the coating matrix (i.e., in embodiments with the particles embedded with a coating matrix).

As such, precise control over the UV-absorbing/blocking ability of the coatings described herein is possible by controlling the coating thickness, the relative concentration of UV-absorbing light scattering particles in the coating, and amount of matrix containing the UV-absorbing material. These parameters may be easily adjusted and/or consistently reproduced.

Therefore, the methods described herein provide a single-step procedure for forming anti-glare coatings with controllable UV-absorbing properties. As a result, significant cost savings are provided through reduced capital costs and increased yields. Additionally, the anti-glare coatings described herein provide increased UV protection for a given coating thickness when using UV absorbing materials in the matrix in addition to filling the light scattering particles, as compared to the conventional practice of having the UV absorbing material in only in the matrix or as a separate coating. Further, improved retention of extractable or volatile UV absorbing materials is provided due to reduced diffusivity when contained in porous and core-shell type particles (tortuous path) when compared to having the UV absorbing material dispersed/dissolved in the matrix. This provides improved chemical, environmental and thermal stability to the UV protective feature.

Thus, in some embodiments, a method for forming an anti-glare coating is provided. A substrate is provided. A coating is formed above the substrate. The coating includes a plurality of micro-particles and has a surfaces roughness of between 0.2 and 0.8 μm. Each of the micro-particles within the plurality of micro-particles includes an UV absorbing material.

In some embodiments, a method for forming an anti-glare coating is provided. A transparent substrate is provided. A coating is formed above the substrate. The coating includes a plurality of micro-particles and has an effective surfaces roughness of between 0.2 and 0.8 μm. Each of the micro-particles within the plurality of micro-particles includes an UV absorbing material. The UV-absorbing material includes a benzophenone (BP) derivative, a benzotriazole (BTA) derivative, a 2-hydroxyphenyl-s-triazine (HPT) derivative, a cyanoacrylate derivative, nano zinc oxide, nano titanium dioxide, nano cerium oxide, or a combination thereof. The plurality of micro-particles has a size distribution of between 0.1 and 10 μm.

In some embodiments, a coated article is provided. The coated article includes a substrate and an anti-glare coating formed above the substrate. The coating includes a plurality of micro-particles and has an effective surfaces roughness of between 0.2 and 0.8 μm. Each of the micro-particles within the plurality of micro-particles includes an UV absorbing material.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method for forming an anti-glare coating, the method comprising:
providing a substrate; and
forming a coating above the substrate, wherein the coating comprises a plurality of micro-particles and has an effective surface roughness of between 0.2 and 0.8 micrometers (μm), wherein each of the micro-particles within the plurality of micro-particles comprises an ultraviolet (UV) absorbing material, and wherein the UV absorbing material comprises a 2-hydroxyphenyl-s-trizine derivative, nano zinc oxide, nano titanium dioxide, nano cerium oxide, or a combination thereof.

2. The method of claim 1, wherein the plurality of micro-particles has a size distribution of between 0.1 and 10 μm.

3. The method of claim 1, wherein the plurality of micro-particles comprises zeolite micro-particles.

4. The method of claim 1, wherein each of the micro-particles within the plurality of micro-particles comprises a plurality of pores and the UV absorbing material is embedded into the plurality of pores.

5. The method of claim 1, wherein each of the micro-particles within the plurality of micro-particles comprises an outer shell and an inner core, and wherein the UV absorbing material is embedded into the inner cores of the plurality of micro-particles.

6. The method of claim 1, wherein the coating further comprises a matrix material, wherein the plurality of micro-particles is embedded within the matrix material.

7. The method of claim 6, wherein the matrix material comprises a second UV absorbing material.

8. The method of claim 1, wherein the forming of the coating above the substrate comprising applying a sol-gel formulation to the substrate.

9. A method for forming an anti-glare coating, the method comprising:
providing a transparent substrate; and
forming a coating above the substrate, wherein the coating comprises a plurality of micro-particles and has an effective surface roughness of between 0.2 and 0.8 micrometers (μm), and wherein each of the micro-particles within the plurality of micro-particles comprises an ultraviolet (UV) absorbing material and zeolite,
wherein the UV absorbing material comprises a benzophenone derivative, a benzotriazole derivative, a 2-hydroxyphenyl-s-triazine derivative, a cyanoacrylate derivative, nano zinc oxide, nano titanium dioxide, nano cerium oxide, or a combination thereof, and wherein the plurality of micro-particles has a size distribution of between 0.1 and 10 μm.

10. The method of claim 9, wherein each of the micro-particles within the plurality of micro-particles comprises a plurality of pores and the UV absorbing material is embedded into the plurality of pores.

11. The method of claim 9, wherein each of the micro-particles within the plurality of micro-particles comprises an outer shell and an inner core, and wherein the UV absorbing material is embedded into the inner cores of the plurality of micro-particles.

12. The method of claim 9, wherein the coating further comprises a matrix material, wherein the plurality of micro-particles is embedded within the matrix material, wherein the matrix material comprises a second UV absorbing material.

13. The method of claim 9, wherein the forming of the coating above the substrate comprising applying a sol-gel formulation to the substrate.

14-20. (canceled)

21. The method of claim 9, wherein the UV absorbing material comprises a 2-hydroxyphenyl-s-trizine derivative, nano zinc oxide, nano titanium dioxide, nano cerium oxide, or a combination thereof.
